(19) United States
(12) Patent Application Publication
(10) Pub. No.: US 2007/0090030 A1
(43) Pub. Date: Apr. 26, 2007

(54) Complete Water Management Process and System

(76) Inventors: Alfredo J. Teran, Cape Canaveral, FL (US); Richard G. Wood, Merritt Island, FL (US); Nidal A. Samad, Merritt Island, FL (US); W. Todd Willoughby, Athens, AL (US); Louis V. Mangiacapra, Mims, FL (US)

Correspondence Address: SMITH HOPEN, PA, 180 PINE AVENUE NORTH, OLDSMAR, FL, 34677, US

(21) Appl. No.: 11/163,623

(22) Filed: Oct. 25, 2005

(51) Int. Cl. B01D 35/14

(52) U.S. Cl. 210/86; 210/202; 210/241; 210/192; 210/96.1; 210/151; 210/103; 210/149

(57) ABSTRACT

A complete water management system employing a plurality of tanks to control the use of potable, gray, and black water. The system is centrally controlled and continuously monitors the condition of all reservoirs, (i.e. the potable, the gray, and the black). The same controller also manages the treatment and interaction between the three reservoirs.

### BACKGROUND OF THE INVENTION

Due to climate changes and increased demand, water shortages have become commonplace throughout the world. Even areas that have traditionally had adequate rainfall and water supplies are feeling the burden placed by the increasing demand for water. Increasing this burden is the misuse of the water that is available. For example, studies have shown that, in the U.S., as much as 80% of the potable water supplied to an average residence goes to uses that do not require potable water. This includes 40% going to toilet flushing and another 40% going to bathing. In fact, only 10% of an average residence's water use requires water meeting most public health requirements (this includes water used for drinking, food preparation, and food-prep material cleaning).

One method of lessening the demand on clean water supplies is to employ “gray-water” for those uses that do not require potable (such as toilet flushing and outdoor irrigation). As its name suggests, graywater is not as clean as potable water. Instead graywater lies on a continuum between potable water and black-water. The most common source for blackwater in the domestic setting is the toilet. However, any water that contains relatively high concentration levels of organic waste is considered blackwater. For this reason kitchen sinks, garbage disposals and dishwashers can be considered sources of blackwater. Graywater is generated from those residential water sources other than blackwater sources and can include bathing sources, bathroom sinks, washing machines (clothes).

Graywater treatment and recycling systems are not new. Graywater methods have been in use since the 1970s. Previously however, graywater has been suitable only for subsurface irrigation of non-edible landscape plants. Even with this limited scope of use the advantages are obvious. Any graywater used replaces, and conserves, potable water. The benefits cannot only be seen in the availability of potable water, but the decreased cost in a residential water budget.

Although graywater has the potential to carry pathogens, Blackwater is regarded as a much higher risk as it is a viable medium for waterborne diseases. Blackwater also carries a high biodegradable organic carbon load that can adversely affect natural water bodies. The contaminant load of blackwater provides a ready food source for microorganisms that can deplete the oxygen from the water and cause an environmental disaster.

In addition to the carbon load of blackwater, there are concerns regarding the high levels of nitrogen, phosphorous, odor and particulate (solid) matter. For these reasons, the disposal of blackwater from mobile sources (i.e. RVs, boats, trains, cruiseships and planes) require approved collection facilities. Such facilities are often scarce and do not provide 24-hour service, increasing the risk of “the occasional” transgressor disposing of the blackwater in an unauthorized fashion.

The traditional method for treating blackwater in residential buildings is the on-site treatment system, septic tank, or connecting directly to a municipal sewer line. Although these methods require little to no attention by the homeowner, they can cause significant problems when malfunctions occur. Additionally, the cost of the municipality to treat the wastewater is passed to the consumer both in taxes as well as the cost (albeit reduced) for reclaimed water.

Therefore, what is needed is a complete wastewater management system than can produce a clear and disinfected product that can be readily used without fear of illness or the transmission of pathogens.

### SUMMARY OF THE INVENTION

The instant invention provides a system whereby a user can satisfy all of his/her water consumption needs while minimizing waste of potable water.

The present invention includes a wastewater treatment system comprising generally of three (3) reservoirs. The first reservoir is a potable water subsystem in valved fluid communication with a potable water user source (sinks, baths, showers, etc.). The second reservoit is a gray water subsystem in valved fluid communication with a drain associated with at least one potable water user source and at least one toilet whereby water used by the potable water source passes to the gray water subsystem and is used for toilet flushing. The third reservoir is a black water subsystem in valved fluid communication with at least one blackwater source whereby water passes to the black water subsystem upon use. The movement of water through the system is controlled by a programmable logic controller (PLC). In one embodiment, a water filter is disposed between the gray water subsystem and potable water subsystem. The filter can be of any type, such as a reverse-osmosis filter.

In another embodiment, the graywater subsystem further comprises a water level sensor communicatively coupled to the PLC, an ORP sensor communicatively couple to the PLC for transmitting a signal responsive to the detection of a predetermined ORP level in the water, and a disinfection/oxidation loop. Water enters the disinfection/oxidation loop responsive to the detection of a predetermined ORP level in the water. An oxidation source, such as an ozone generator, is placed in valved fluid communication with the disinfection/oxidation loop. This allows treatment of the water as it flows through the loop.

In another embodiment, the potable water subsystem further comprises a water level sensor, an ORP sensor communicatively coupled to the PLC for transmitting a signal responsive to the detection of a predetermined ORP level in the water, and a disinfection/oxidation loop. Water enters the disinfection loop responsive to the detection of a predetermined ORP level in the water. As with the graywater subsystem, an oxidation source, such as an ozone generator, is in valved, fluid communication with the disinfection loop.

In yet another embodiment, the blackwater subsystem further comprises a water level sensor, a temperature sensor, a heater, and a mixing/aeration loop. A settling unit is placed in valved fluid communication with the blackwater subsystem and graywater tank. The settling unit is chosen from the group consisting of a column and conical-bottom tank and further comprises a level sensor communicatively coupled to the PLC.

In an alternate embodiment, the blackwater subsystem further comprisestwo (2) tanks, an oxic tank having a mixing/aeration loop and an anoxic tank having a mixing loop in valved fluid communication with the oxic tank. A settling unit is placed in valved fluid communication with the anoxic tank. As with the previous embodiment, the settling unit is chosen from the group consisting of a column and conical-bottom tank and comprises a level sensor communicatively coupled to the PLC.

In yet another embodiment, a macerator pump is disposed between at least one blackwater source and the blackwater subsystem.

### BRIEF DESCRIPTION OF THE DRAWINGS

For a fuller understanding of the nature and objects of the invention, reference should be made to the following detailed description, taken in connection with the accompanying drawings, in which:

FIG. 1 is a perspective view of the potable water tank.

FIG. 1A is a perspective view of the disinfection loop in the potable water subsystem.

FIG. 2 is a perspective view of the graywater tank.

FIG. 2A is a perspective view of the disinfection loop in the gray water subsystem.

FIG. 3 is a perspective view of the blackwater tank.

FIG. 3A is a perspective view of the mixing/aeration loop.

FIG. 3B is a perspective view of an alternate blackwater subsystem.

FIG. 4 is a perspective view of the settling column apparatus.

FIG. 5 is a diagrammatic view of the oxic biologic process whereby organic nitrogen and ammonia are converted to nitrite and nitrate.

FIG. 6 is a diagrammatic representation of the process whereby nitrate and nitrite are reduced to atmospheric nitrogen.

FIG. 7 is a diagrammatic representation of the total water management system.

### DETAILED DESCRIPTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

Terms

With regard to present disclosure above and below, the following terms are to be understood as follows.

Graywater—as used herein refers to any water that has been used in the home, except water from toilets or sources which generate organic waste (i.e. garbage disposals).

Blackwater—as used herein refers, generally, to water generated in toilets and garbage disposals but can include any source which generates wastewater with a relatively high concentration of organic matter.

Primary Use—as used herein refers to water use which requires water to be potable quality. Examples include drinking water, food preparation and cleaning of items used for food preparation. Although some activities, such as laundry and the like, do not require potable quality water, they are often connected to potable water sources.

Secondary Use—as used herein refers to water use in which it is not necessary for the water to be potable as long as microbial and organic constituents are low, or non-existent. Examples include toilet flushing, irrigation and the like.

Tertiary Water Use—as used herein refers to uses such as recycling and purification. For example, a tertiary use of blackwater would be diversion to the settling column of the present invention.

Potable Water User Source—any source wherein the user would expect, or require, at the time of use that the water be potable. Examples include showers, tubs, sinks and faucets.

Graywater User Source—any source wherein the quality of water need not be potable as long as microbial and organic constituents are low, or nonexistent. Examples include clothes washers (TDS<1,000 ppm), irrigation, toilet flushing.

Blackwater Generation Source—as used herein refers to any source of blackwater. Examples include toilets and garbage disposals.

Programmable Logic Controller (PLC)—as used herein refers to any device used to automate monitoring and control of the inventive system and process.

The system of the present invention comprises three water tanks (each with a water level sensor); a potable water tank, a graywater tank and a blackwater tank. The system also includes a programmable logic controller (PLC), oxidation reduction potential sensors (ORPs), an electric heater, a temperature sensor, a settling column, contact columns, an oxygen concentrator, an ozone generator, venturis, water pumps and a power source.

Potable Water Subsystem

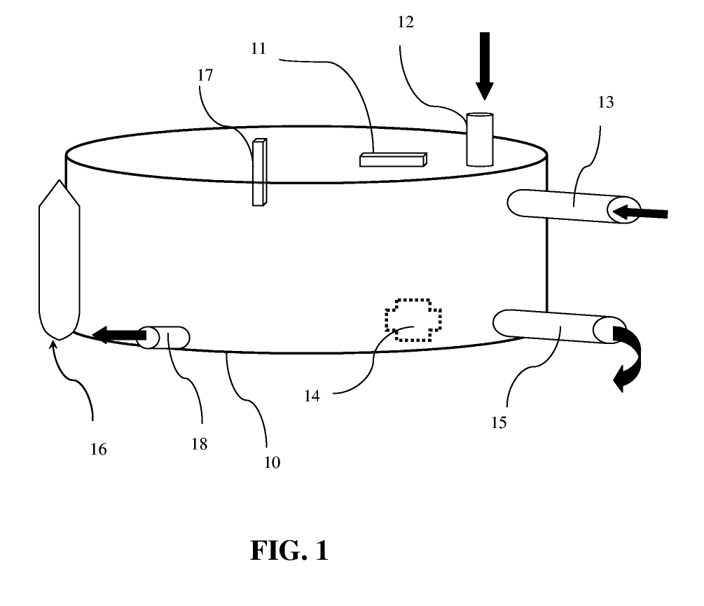

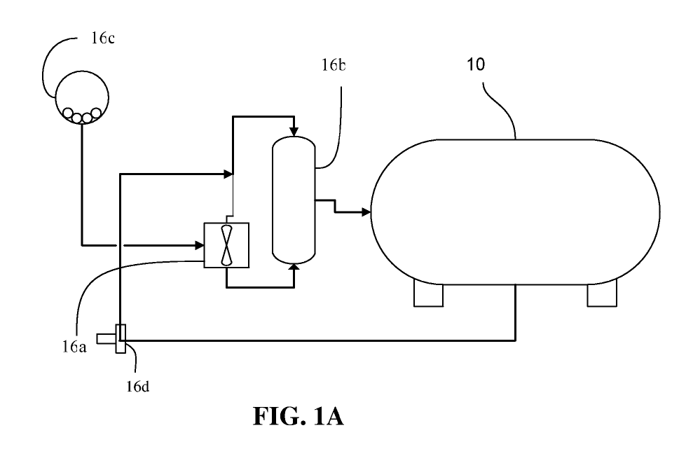

FIG. 1 is a perspective view of one embodiment of the present invention. This portion of the system comprises potable water tank 10. Potable water tank 10 is equipped with; level sensor 17, vent 11, ORP Sensor 14, fresh water fill line 12, egress line 18, drain 15, and treated-recycled water fill line 13. A disinfection loop is represented as a whole by the numeral identifier 16. Disinfection loop 16 (shown in FIG. 1A), further comprises venturi 16a, contact column 16b, ozone generator 16c, and pump 16d.

Potable water enters the potable water tank 10 through the fresh water fill line 12 from any source. Typically this source will be either a municipal water facility or a well. Water can be directly pumped from potable water tank 10 through egress line 18 to any user source in the residence. Most commonly these sources will include a shower/tub, dishwashers, clothes washers and sinks or faucets. Water level sensor 17 monitors the level of the water in potable water tank 10 and communicates the information to the programmable logic controller (not shown). Drain 15, can drain to any suitable source and most commonly will lead to a municipal sewer line or septic tank. Since only potable water is kept in tank 10, it is possible for the drain to lead to virtually any source which can accept water. Vent 11 provides a release for any gases which could potentially develop in tank 10 (i.e. in case of contamination). This safety feature also prevents the tank from rupturing due to pressure as well as venting ozone from the disinfection loop. The vent is equipped with an ozone destruct unit (not shown), which converts the vented ozone gas into elemental oxygen so there are no safety issues with ozone gas being released from the tank.

Oxidation reduction potential (ORP) sensor 14 resides within potable water tank 10 and is communicatively connected to the PLC. ORP is generally measured in millivolts (mV) and provides an extremely accurate measure of the quality of water within tank 10. As its name suggests, ORP measures the oxidizing activity of the water. Although ORP offers many advantages over other “real time” monitoring methods, such as pH monitoring, any method capable of accurately determining the quality of water in tank 10 and communicating said information to the PLC may be utilized.

Water may also enter tank 10 from a water purification and filtration unit (discussed below), that may include reverse osmosis filtration (not shown in FIG. 1), through inlet 13. Water residing in the tank can be further purified by passing through the disinfection loop 16. When a target ORP level is detected by the ORP sensor, the PLC activates a pump 16d which channels the water into disinfection loop 16. Upon activation, ozone generator 16c feeds ozone to venturi 16a of the disinfection loop. The water then enters the contact column 16b allowing the oxidation reaction to take place as the ozone gas is dissolved into the water. From contact column 16b, the water then re-enters the potable water tank. As the oxidation reaction reaches a predetermined value, the disinfection process stops and the water circulation stops as well. In one embodiment, water is sent through the disinfection loop whenever the lower limit ORP setting is reached which ensures the contents of the tank stay free of microorganisms, for continuing consumption.

Graywater Subsystem

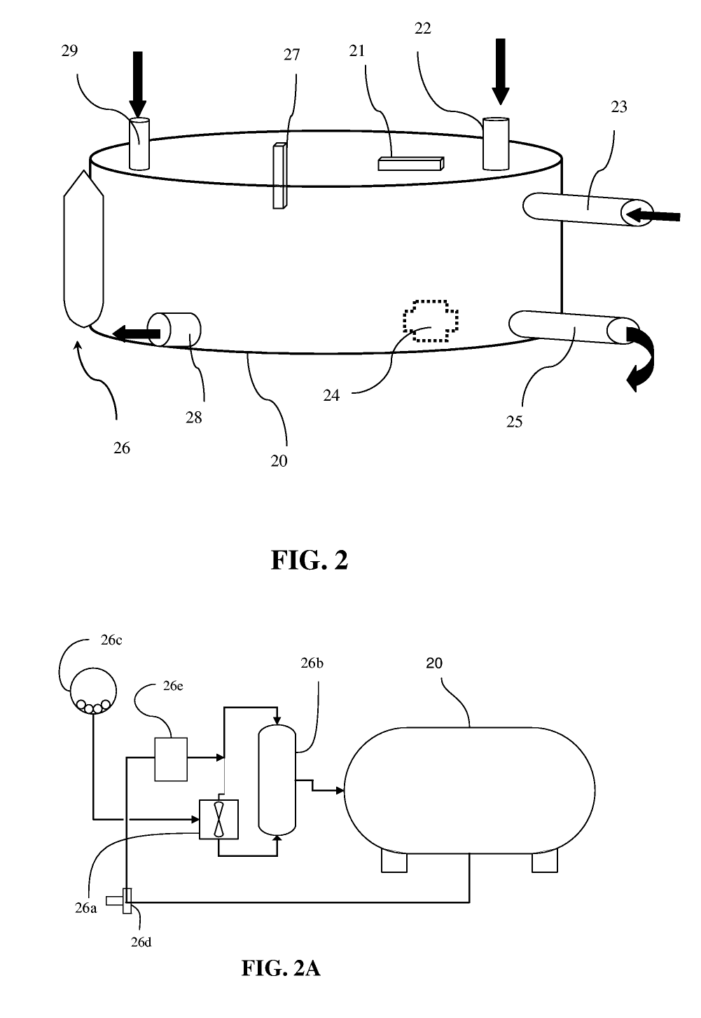

FIG. 2 is a perspective view of one embodiment of the graywater subsystem. The graywater subsystem comprises graywater tank 20, which is similar to potable water tank 10. Graywater water tank 20 is also equipped with; level sensor 27, vent 21, ORP sensor 24, egress line 28, drain 25, and treated-recycled water fill line 23. Graywater tank 20 receives water from a graywater inlet 22 or settling column/tank inlet 29 (settling column not shown in FIG. 2). Graywater sources feeding inlet 22 can be any potable water or graywater source, such as a bathroom sink or shower drain. A disinfection/oxidation loop is represented as a whole by the numeral identifier 26. Disinfection loop 26 (shown in FIG. 2A), further comprises venturi 26a, contact column 26b, ozone generator 26c and pump 26d. Optionally, particulate filter 26e can be installed in the disinfection/oxidation loop.

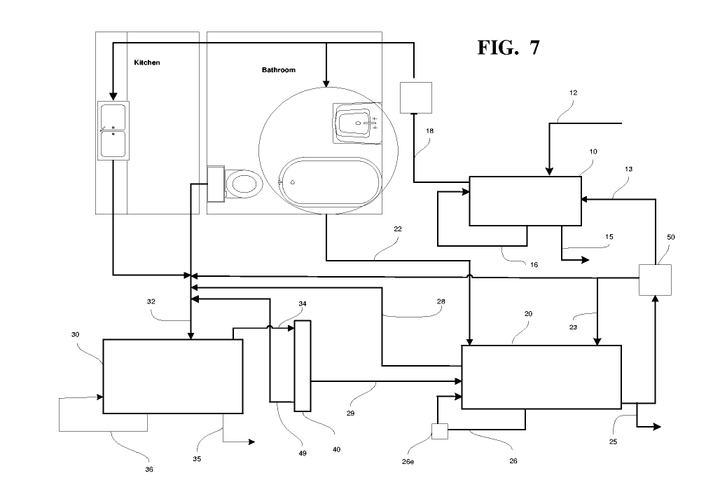

Disinfection/oxidation loop 26 of the graywater tank works in identical fashion to that of the disinfection loop of the potable water tank 10 (discussed supra). After water leaves the disinfection loop and reenters graywater tank 20, it can then be pumped through egress line 28 for a suitable use (such as flushing or irrigation). Water leaving tank 20 via the egress line 28 can travel to a blackwater use source (i.e. toilet), however, water in line 28 can also be diverted to the blackwater tank 30 (not shown in FIG. 2). Alternatively, the graywater can also be pumped out of drain 25 where it will either leave the system or enter filtration unit 50 (FIG. 7). If the water is diverted to filtration unit 70 it can be recycled to the potable water tank 10. Water passing through the filtration system, but not meeting predetermined standards of purity, can also re-enter the graywater tank 20 through the treated-recycled water fill line 23 or blackwater subsystem 30 via inlet 32. The tank is vented in the same manner as in the potable water tank, discussed above. Ozone gas is vented through an ozone destruct unit (not shown) so no ozone is released from the tank.

Blackwater Subsystem

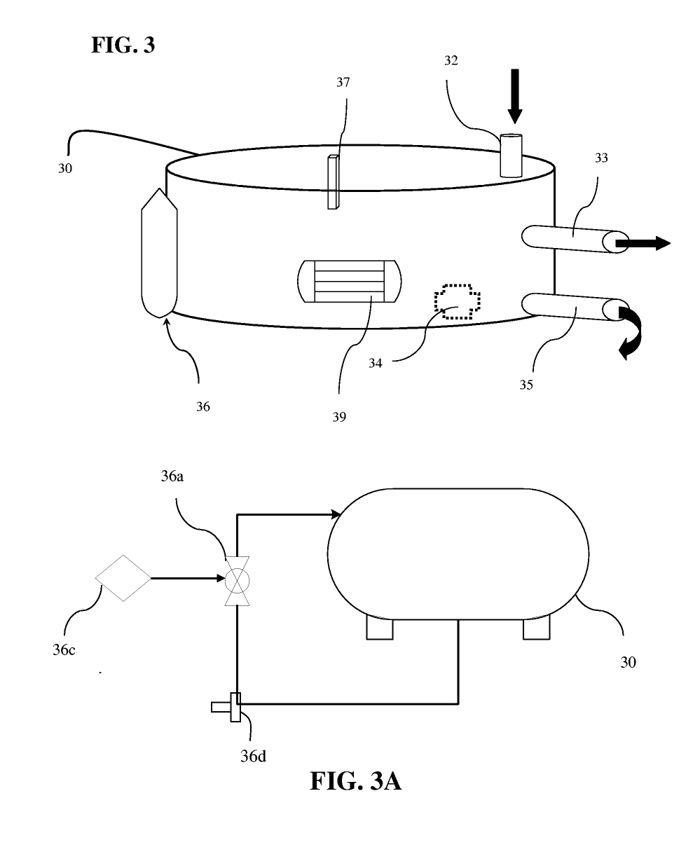

FIG. 3 is a perspective view of one embodiment of the blackwater system which comprises blackwater subsystem 30. Blackwater subsystem 30 is also equipped with; water egress line 33, water source inlet 32, a level sensor 37, a temperature sensor 34, an electric heater 39, and a drain 35. Blackwater subsystem 30 receives water from all blackwater user sources in the system through source inlet 32. This also includes water coming from graywater tank 20 that is diverted to blackwater subsystem 30. Water also enters the tank from the filtration unit through inlet 32. In one embodiment the blackwater in blackwater subsystem 30 is not discharged unless the tank requires maintenance. Instead, the water in blackwater subsystem 30 is circulated through the tank via a mixing/aeration loop 36 (FIG. 3A). The mixing/aeration loop 36 consists of venturi 36a, solenoid valve 36b and pump 36c. While in mixing/aeration loop 36, the water is treated with bacteria and solenoid valve 36b is opened or closed by the PLC depending upon whether the mixing process is oxic or anoxic. The temperature in the blackwater subsystem is monitored by temperature sensor 34 which is communicatively coupled to the PLC.

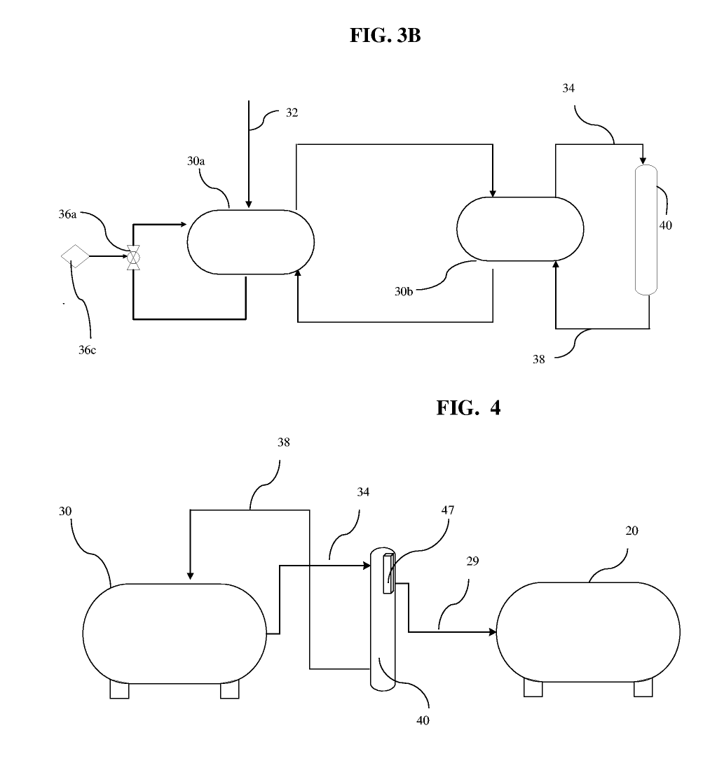

As the water in blackwater subsystem 30 is treated, it is periodically cycled to settling unit 40 (i.e. column, vertical, or conical tank) via conduit 34 as shown in FIGS. 4 and 7. Settling unit 40 is equipped with level sensor 47, which stops the cycling when the unit is full. The activated sludge settles to the bottom of settling unit 40 and a purified layer, or supernate, is formed above the sludge layer. The supernate is then transferred to graywater tank 20 via inlet 29 (FIG. 2) where the oxidation process and the disinfection process are coupled in graywater tank 20's oxidation/disinfection loop. This supernatant layer from settling unit 40 is the only water which leaves blackwater subsystem 30. All other water is recycled from settling unit 40 to blackwater subsystem 30 via conduit 38 which connects to inlet 32. The frequency of the filling and draining of settling unit 40 is controlled by the PLC.

In an alternative embodiment, shown in FIG. 3B, two tanks are used to create the blackwater subsystem. In this embodiment, an oxic 30a and anoxic tank 30b are kept in valved fluid communication. In this manner, the bacteria can be kept in an optimum environment and are not harmed as the environment of a single tank is changed from oxic to anoxic.

Bacterial Treatment of Wastewater

Generally, the biological treatment of the wastewater is achieved in two (2) steps. In the first step (Oxic Step) the wastewater begins in a storage tank and enters a mixing loop, where it is mixed with air, or oxygen, thus ensuring that the bacteria remain in contact with the column of wastewater. A mixing loop can be any device that allows the introduction of a gas, here oxygen or air, and provides for the gas to be dissolved in water. Examples include a venturi followed by a static mixer or a simple bubble-diffuser and contact column or merely turbulent flow created upon re-entry into the holding tank 30. The water then re-enters the holding tank

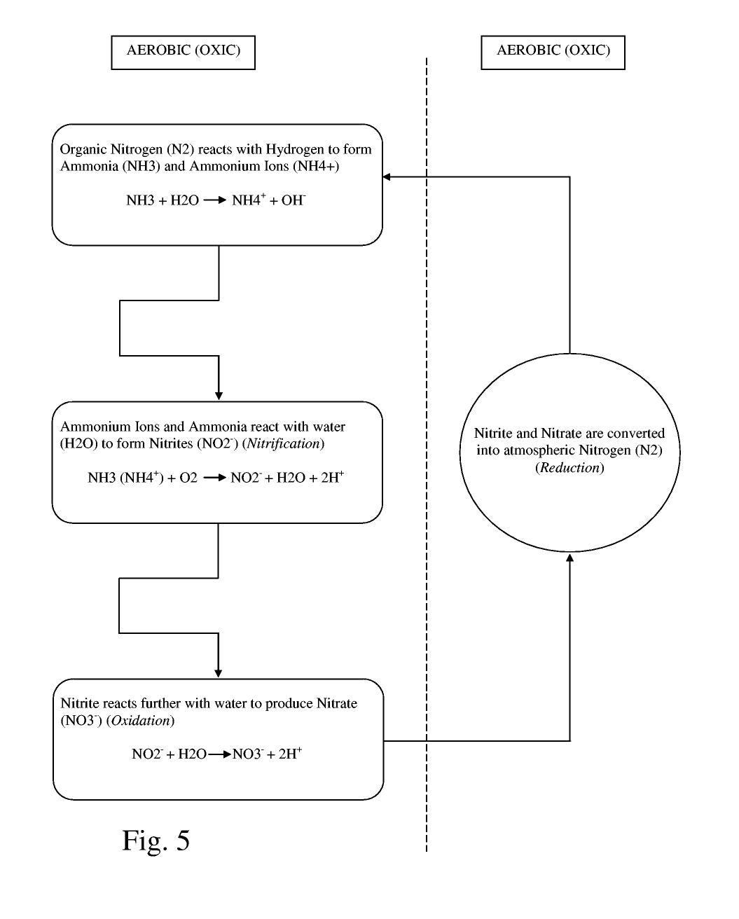

The process whereby the organic nitrogen present in the wastewater is converted into nitrite and nitrate is delineated in FIG. 5. Organic nitrogen combines with hydrogen to form ammonia and ammonium ions. These two elements are in constant flux, and continue to change states. In the presence of water beneficial bacteria, such as Nitrosomonas, convert the ammonia and ammonium ions to Nitrites (NO₂). Finally, another strain of bacteria, such as Nitrobacter, converts the Nitrite (NO₂) to Nitrate (NO₃).

The second step (Anoxic Step) is a continuation of the biological filtration and is achieved anaerobically. The wastewater is passed through the same mixing loop but without exposure to oxygen. It is in this step that the denitrifying bacteria reduces nitrate-nitrogen produced in the oxic phase into nitrogen and nitrogen-oxide gases, which are released from the wastewater. After passing through the mixing loop the wastewater re-enters the holding tank.

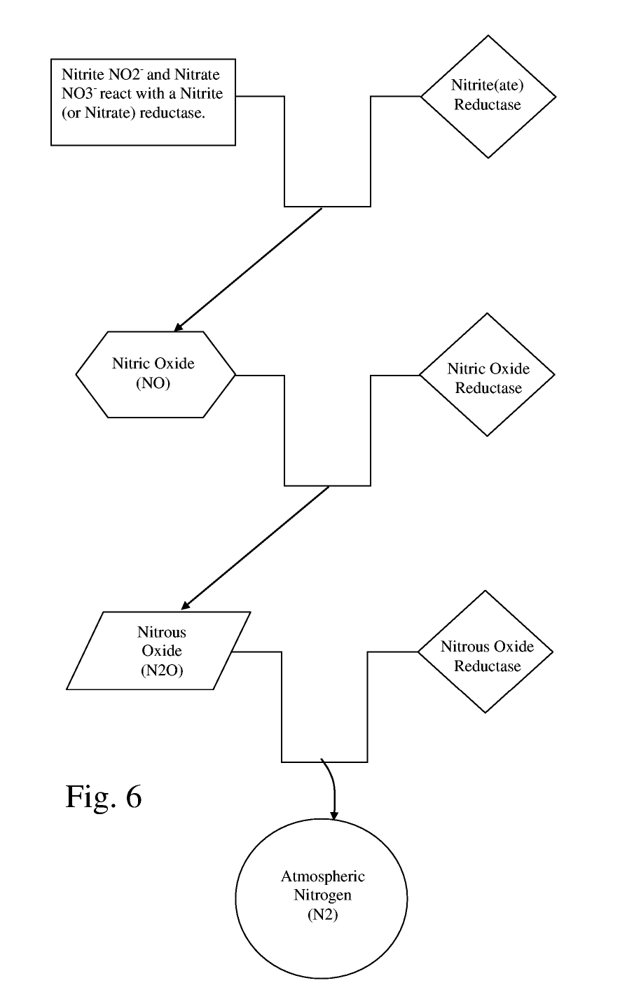

The anoxic phase is illustrated in FIG. 6. Nitrate and nitrite, through microbial action, react with a reductase (any catalyst which will begin the reaction) to nitric oxide (NO). Subsequently the nitric oxide is converted to nitrous oxide (N₂O), 30, and is finally reduced to atmospheric nitrogen (N₂).

The Combined Systems

A schematic view of one embodiment comprising a water treatment system is provided in FIG. 7. Here it can be seen that potable water from tank 10 is consumed at a user source and then plumbed to graywater tank 20. Where the potable water is consumed at a blackwater user source (here a kitchen sink), the water is transferred to blackwater subsystem 30

To maximize efficiency of the system, a minimal amount of particulate matter is transferred to graywater tank 20. Once in graywater tank 20 the water enters oxidation/disinfection loop 26. Although this embodiment uses ozone, any oxidant is acceptable if used in sufficient amounts to achieve the intended result and does not leave any contaminating residue after oxidation. In this embodiment ozone (O₃) from ozone generator 26c is fed into venturi 26 a(FIG. 2A). The water then enters contact column 26b wherein the oxidation reaction occurs. From contact column 26b, the water re-enters graywater tank 20. ORP value is constantly monitored by the PLC. As the oxidation reaches completion and the ORP reaches a predetermined value, the oxidation process stops and water circulation through loop 26 is ceased. In alternate embodiments the water is exposed to the oxidation process at least once every 24 hours regardless of the ORP levels.

Blackwater is, logically, plumbed to blackwater subsystem 30. It is important to note that blackwater generated at sources such as kitchen sinks originates as potable water, whereas blackwater from toilets originated as graywater from graywater tank 20. Blackwater generated from the toilet passes through a macerator pump 60 (FIG. 7) before entering blackwater subsystem 30. The macerator pump serves to crush and break the solids of the wastewater into smaller particles. The biological processes occurring in blackwater subsystem 30 remove odor from the blackwater and drastically reduces the biochemical oxygen demand (BOD). BOD is a measure of the quantity of oxygen consumed by microorganisms during the decomposition of organic matter. BOD is the most commonly used parameter for determining the oxygen demand on the receiving water of a municipal or industrial discharge. BOD is used to evaluate the efficiency of treatment processes, and is an indirect measure of biodegradable organic compounds in water.

Odor, BOD, as well as the nutrients and solids in the blackwater are reduced by the sequencing computer program, run in the PLC, which alternates the environmental conditions of the blackwater subsystem (such as oxic and anoxic conditions). The nutrients of concern in domestic wastewater are nitrogen and phosphorous. The removal of these nutrients greatly depends on their chemical speciation, which is dependant on the environmental conditions (oxic versus an-oxic).

The mixing of the bacteria in blackwater tsubsystem 30 is critical to the success of the biological process. Referring now to FIG. 3(A), blackwater subsystem 30 is equipped with a mixing/aeration loop 36. Mixing/aeration loop 36 is comprised of pump 36 d that forces the blackwater through venturi 36 a and back into blackwater subsystem 30. The venturi is used to introduce air containing oxygen) to the blackwater. Any means of introducing oxygen (O₂) is acceptable, whether it is pure oxygen or ambient air containing sufficient oxygen. In one embodiment solenoid valve 36b is attached tventuri 36a. If oxic conditions are desired, the PLC will open valve 36b, thus allowing air to be introduced into the blackwater flow. If an-oxic conditions are desired, valve 36b will close and no air will be introduced. Even during anoxic conditions, however, the bacteria (or activated sludge) are mixed with the blackwater.

In an alternative embodiment two tanks are used to create the blackwater subsystem. In this embodiment, an oxic 30a and anoxic tank 30b are kept in valved fluid communication. In this manner, the facultative bacteria can be kept in an optimum environment and are not harmed as the environment of a single tank is changed from oxic to anoxic. Responding to a predetermined BOD value, water is transferred between the anoxic and oxic tanks. Mixing/aeration loop 36 is kept in valved fluid communication oxic tank 30a whereas the mixing loop attached to the anoxic tank 30b (not shown) does not, as its name suggests, provide access to oxygen. This design insures that, even in the anoxic tank where oxygen is not introduced, that the facultative bacteria are mixed with the blackwater. Anoxic tank 30b is kept in valved fluid communication with settling unit 40.

It will be seen that the objects set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described,

What is claimed is:

1. A wastewater treatment system comprising:
a potable water subsystem in valved fluid communication with a potable water user source;
a gray water subsystem in valved fluid communication with a drain associated with at least one potable water user source and at least one toilet whereby water used by the potable water source passes to the gray water subsystem and is used for toilet flushing;
a black water subsystem in valved fluid communication with at least one blackwater source whereby water passes to the black water subsystem upon use.

2. The wastewater treatment system of claim 1 wherein the system is installed on a vehicle selected from the group consisting of RVs, boats, trains, cruiseships and planes.

3. The wastewater treatment system of claim 1 wherein movement of water is controlled by a programmable logic controller (PLC).

4. The wastewater treatment system of claim 1 wherein a water filter is disposed between the gray water subsystem and potable water subsystem.

5. The wastewater treatment system of claim 4 wherein the water filter is a reverse-osmosis filter.

6. The wastewater treatment system of claim 1 further comprising an oxidation source.

7. The wastewater treatment system of claim 6 wherein the oxidation source is an ozone generator.

8. The wastewater treatment system of claim 3 wherein the graywater subsystem further comprises:
a water level sensor communicatively coupled to the PLC;
an ORP sensor communicatively couple to the PLC for transmitting a signal responsive to the detection of a predetermined ORP level in the water; and
a disinfection/oxidation loop.

9. The wastewater treatment system of claim 8 wherein water enters the disinfection/oxidation loop responsive to the detection of a predetermined ORP level in the water.

10. The wastewater treatment system of claim 8 further comprising an oxidation source.

11. The wastewater treatment system of claim 10 wherein the oxidation source is an ozone generator.

12. The wastewater treatment system of claim 10 wherein the oxidation source is in valved fluid communication with the disinfection/oxidation loop.

13. The wastewater treatment system of claim 3 wherein the potable water subsystem further comprises:
a water level sensor;
an ORP sensor communicatively coupled to the PLC for transmitting a signal responsive to the detection of a predetermined ORP level in the water; and
a disinfection/oxidation loop.

14. The wastewater treatment system of claim 13 wherein water enters the disinfection loop responsive to the detection of a predetermined ORP level in the water.

15. The wastewater treatment system of claim 13 further comprising an oxidation source.

16. The wastewater treatment system of claim 15 wherein the oxidation is an ozone generator.

17. The wastewater treatment system of claim 15 wherein the oxidation source is in valved, fluid communication with the disinfection loop.

18. The wastewater treatment system of claim 3 wherein the blackwater subsystem further comprises:
a water level sensor;
a temperature sensor;
a heater; and
a mixing/aeration loop.

19. The wastewater treatment system of claim 18 further comprising a settling unit in valved fluid communication with the blackwater subsystem and graywater subsystem.

20. The wastewater treatment system of claim 19 wherein the settling unit is chosen from the group consisting of a column and conical-bottom tank.

21. The wastewater system of claim 19 wherein the settling unit further comprises a level sensor communicatively coupled to the PLC.

22. The wastewater treatment system of claim 3 wherein the blackwater subsystem further comprises:
an oxic tank having a mixing/aeration loop; and
an anoxic tank having a mixing loop in valved fluid communication with the oxic tank.

23. The wastewater treatment system of claim 22 further comprising a settling unit in valved fluid communication with the anoxic tank.

24. The wastewater treatment system of claim 23 wherein the settling unit is chosen from the group consisting of a column and conical-bottom tank.

25. The wastewater system of claim 23 wherein the settling unit further comprises a level sensor communicatively coupled to the PLC.

26. The wastewater system of claim 1 wherein a macerator pump is disposed between at least one blackwater source and the blackwater subsystem.
